(19) United States
(12) Patent Application Publication
(10) Pub. No.: US 2016/0349099 A1
(43) Pub. Date: Dec. 1, 2016

(54) LIQUID TANK LEVEL INDICATOR DEVICE AND METHOD

(71) Applicants: Annette H. Carlson, Longmont, CO (US); Charles E. Carlson, Longmont, CO (US)

(72) Inventors: Annette H. Carlson, Longmont, CO (US); Charles E. Carlson, Longmont, CO (US)

(21) Appl. No.: 15/163,967

(22) Filed: May 25, 2016

Related U.S. Application Data
(60) Provisional application No. 62/167,793, filed on May 28, 2015.
(60) Provisional application No. 62/250,020, filed on Nov. 3, 2015.

(51) Int. Cl. G01F 23/72

(52) U.S. Cl. CPC G01F 23/72

(57) ABSTRACT

A liquid tank level indicator device for use with a tank having an exterior surface and an interior surface surrounding a cavity shaped to contain a volume of the liquid. In some embodiments, the device may include a float which is configured to be positioned within the tank cavity. The float may include a buoyancy element and a magnetic material. The device may also include a level indicator which is configured to be positioned on the exterior surface of the tank. The level indicator may include a second magnetic material. The float may be placed within the tank cavity in contact with the liquid and the level indicator may be placed on the exterior of the tank in magnetic communication with the float so that movement of the liquid results in movement of the float and in movement of the level indicator on the exterior surface of the tank.

### CROSS REFERENCE TO RELATED APPLICATIONS

This application claims priority to and the benefit of the filing date of U.S. Provisional Application No. 62/167,793, filed on May 28, 2015, entitled “BEVERAGE KEG LEVEL INDICATING DEVICE”, as well as U.S. Provisional Application No. 62/250,020, filed on Nov. 3, 2015, entitled “LIQUID TANK LEVEL INDICATOR”, which is hereby incorporated by reference in its entirety.

### FIELD OF THE INVENTION

This patent specification relates to a magnetic level indicator for a liquid filled tank. More specifically, this patent specification relates to a magnetic liquid level indicator that may be used to continuously indicate the liquid level within a beverage keg.

### BACKGROUND

Many types and styles of liquid holding tanks exist. This includes soda kegs, also known as Cornelius Kegs, or Corny Kegs (“kegs”), which are commonly used to store and dispense liquid beverages such as beer, wine, and root beer. These kegs are commonly used by Home Brewers (“brewers”) to store and or dispense beer, wine, or other beverages. There are few options available for the keg user to continuously monitor the liquid level in their keg style of tank. There are some commercially available flow meters that allow a keg user to monitor cumulative withdrawals from the keg and these are relatively expensive. There are temperature monitoring strips that may be attached to the outside of kegs that indicate the liquid level based on temperature differential between the liquid and gas phase level in the keg. Relatively expensive load cell systems are also available to monitor beverage consumption based on weight of the keg versus empty weight of the keg.

Other types of liquid level gauges employ permanent magnets for use in large scale liquid tanks in industrial uses. Some of these indicating systems employ a magnetic float within the tank that communicates in some way with an indicator on the outside of the tank. Typically, these gauges utilize an electrical or mechanical level indicating method. For example, a float inside a tank that is guided by a rod to rise and fall vertically with the liquid level, or a float configured to illuminate light indicators exterior to the tank. Other examples include a float containing a permanent magnet, which interacts with a metallic ball in a tube located outside of the tank. The metallic ball rises and falls, within the tube, with the float mounted inside the tank. Other prior art references describe magnetic floats that rise and fall within isolation tubes located outside the tank. None of these prior art examples provide for a liquid level indicator that may be used without altering the structure of an existing beverage keg.

Therefore, a need exists for novel liquid tank level indicator devices. There is a further need for novel liquid tank level indicator devices that are configured to enable a user to continuously monitor the liquid level in their keg style of tank. Finally, there exists a need for novel liquid tank level indicator devices that may be used without altering the structure of an existing beverage keg or tank.

### BRIEF SUMMARY OF THE INVENTION

A liquid tank level indicator device is provided. The device may be used to indicate the amount of a liquid and/or the level of the free surface of a liquid in a tank having an exterior surface and an interior surface surrounding a cavity shaped to contain a volume of the liquid. In some embodiments, the device may include a float which is configured to be positioned within the tank cavity. The float may include a buoyancy element and a first magnetic material. The device may also include a level indicator which is configured to be positioned on the exterior surface of the tank. The level indicator may include a second magnetic material. The float may be placed within the tank cavity in contact with the liquid and the level indicator may be placed on the exterior of the tank so that the first and second magnetic materials are in magnetic communication. Movement of the liquid results in movement of the float and also in movement of the level indicator on the exterior surface of the tank by the magnetic communication between the float and the level indicator.

According to one aspect consistent with the principles of the invention, a method for determining the level of the free surface of a liquid in a tank is provided. The method may be used with a liquid tank level indicator device for determining the level of the free surface a tank having an exterior surface and an interior surface surrounding a cavity shaped to contain a volume of liquid. Preferably, the device may include a float having a body with a buoyancy element and a first magnetic material. Additionally, the device may also comprise a level indicator having a second magnetic material. In some embodiments, the method may comprise the steps of: placing the float within tank cavity so that the float is buoyantly supported by the free surface of the liquid; placing the level indicator on the exterior of tank in magnetic communication with float; removing liquid from the tank cavity so that the free surface of the liquid and the float is lowered to second height; observing the level indicator being pulled across the exterior surface of the tank to the second height by way of the magnetic communication with the float; and ascertaining the height of the free surface of the liquid within the tank to be approximately equal to the second height when the level indicator is at the second height on the exterior surface of the tank.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a perspective view of an example of a liquid tank level indicator device according to various embodiments described herein.

FIG. 2 illustrates a sectional, through line 2-2 shown in FIG. 1, elevation view of an example of a float of a liquid tank level indicator device according to various embodiments described herein.

FIG. 3 shows a sectional, through line 3-3 shown in FIG. 1, elevation view of an example of a level indicator of a liquid tank level indicator device according to various embodiments described herein.

FIG. 4 depicts an elevation view of an example of a liquid tank level indicator device engaged to an exemplary liquid tank with the level indicator visible and at a first height according to various embodiments described herein.

FIG. 5 illustrates a sectional, through line 5-5 shown in FIG. 4, elevation view of the example liquid tank level indicator device engaged to the exemplary liquid tank.

FIG. 6 shows an elevation view of an example of a liquid tank level indicator device engaged to an exemplary liquid tank with the level indicator visible and at a second height according to various embodiments described herein.

FIG. 7 depicts a sectional, through line 7-7 shown in FIG. 6, elevation view of the example liquid tank level indicator device engaged to the exemplary liquid tank.

FIG. 8 illustrates a block diagram of an example of a method for determining the level of the free surface of a liquid in a tank according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

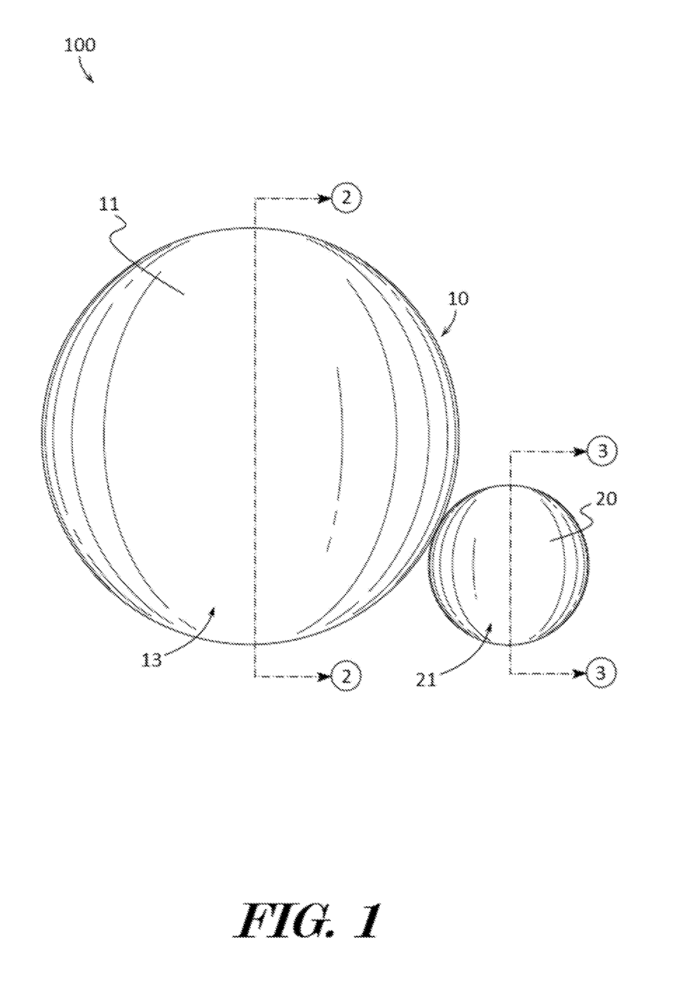

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

New liquid level indication devices and methods are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

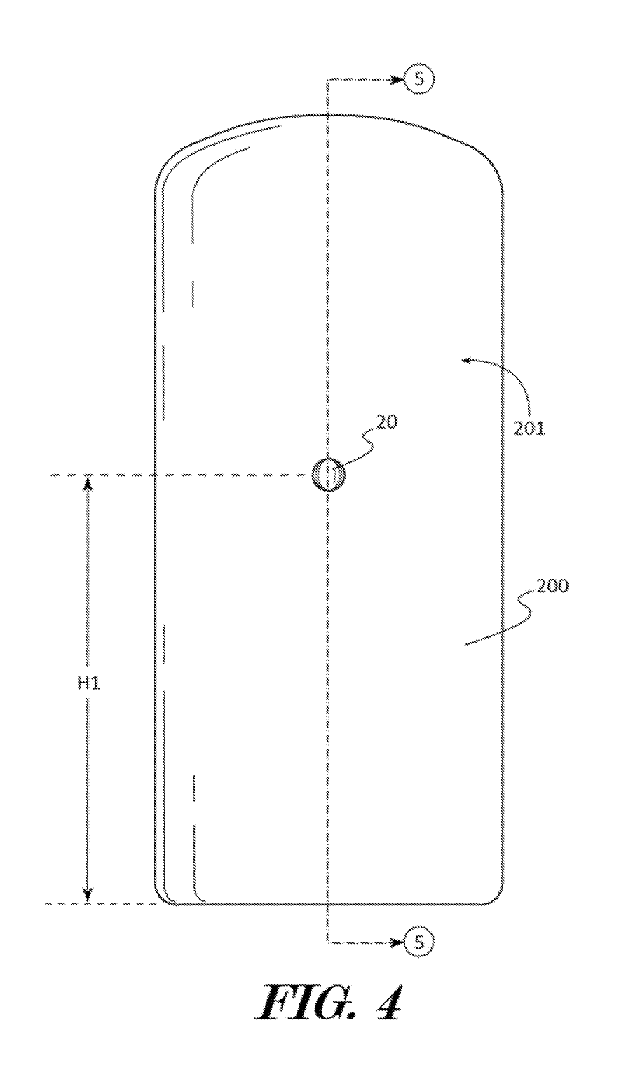

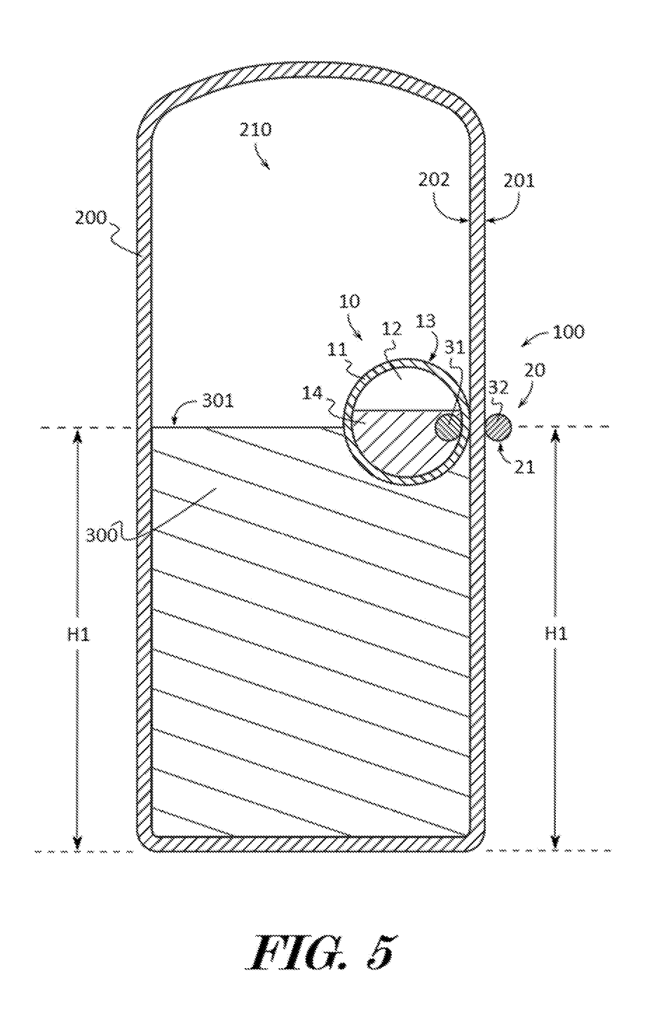

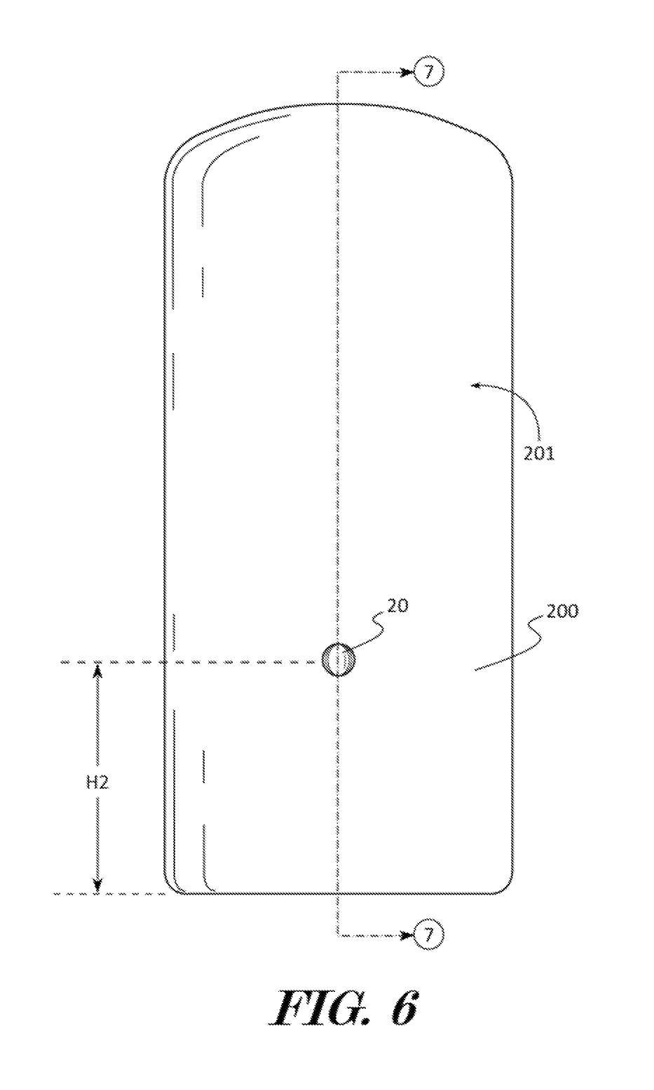

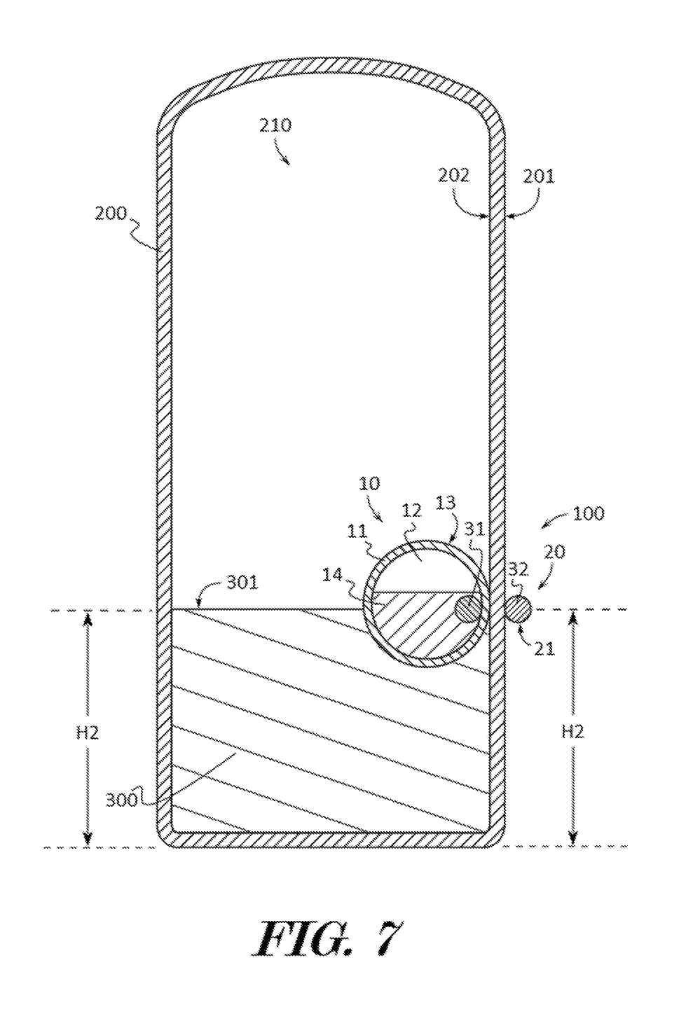

The present invention will now be described by example and through referencing the appended figures representing preferred and alternative embodiments. FIG. 1 illustrates an example of a liquid tank level indicator device (“the device”) 100 according to various embodiments. The device 100 may be used to indicate the amount and/or the free surface 301 (FIGS. 5, 7) of a liquid 300 (FIGS. 5, 7) in a tank 200 (FIGS. 4-7) having an exterior surface 201 (FIGS. 4-7) and also having an interior surface 202 (FIGS. 5, 7) surrounding a cavity 210 (FIGS. 5, 7) shaped to contain a volume of the liquid 300. In this example and in some embodiments, the device 100 may comprise a float 10 which is configured to be positioned within the tank cavity 210. The float 10 may comprise a buoyancy element 12 which may be positioned within the body 11 of the float 10. A first magnetic material 31 may be disposed within the body 11 of the float 10. The device 100 may also comprise a level indicator 20 which is configured to be positioned on the exterior surface of the tank 200. The level indicator 20 may comprise a second magnetic material 32. The float 10 may be placed within the tank cavity 210 in contact with the free surface 301 of the liquid 300 and the level indicator 20 may be placed on the exterior of the tank 200 in magnetic communication with the float 10 so that movement of the free surface 301 of the liquid 300 results in movement of the float 10 and in movement of the level indicator 20, by way of the magnetic communication between the float 10 and the level indicator 20, on the exterior surface 201 of the tank 200.

Turning now to FIG. 2, a sectional elevation view of an example of a float 10 of a liquid tank level indicator device 100 according to various embodiments described herein is illustrated. In some embodiments, the float 10 may comprise a body 10 which may be configured to contact the liquid 300 (FIGS. 5, 7) within the cavity 210 (FIGS. 5, 7) of a tank 200 (FIGS. 4-7). The body 11 may be made from a liquid impermeable material such as plastic, metal and metal alloys, ceramic, carbon fibre, resin, silicone, rubber, and the like. In further embodiments, the body 11 may be made from or comprise a food grade material such as stainless steel, aluminum, copper, other food-grade metals and metal alloys, food-grade nylon, food-grade polyurethane, food-grade vinyl, food-grade polyethylene, food-grade polyvinyl chloride, food-grade rubber, food-grade silicone, food-grade ceramics, and any other material which may be considered food safe such as which may be found in European Union framework Regulation (EC) No. 1935/2004 or the like and/or which may be provided by the U.S. Food and Drug Administration (FDA).

In some embodiments, the body 11 may comprise a float exterior surface 13 which may be configured with a generally spherical shape and which may allow the body 11 to roll along the interior surface 202 (FIGS. 5, 7) of the tank 200 (FIGS. 4-7). In alternative embodiments, the body 11 may optionally comprise one or more movement facilitating devices such as wheels, casters, ball bearings, and the like, which may facilitate the movement of the body 11 across the interior surface 202, and the body 11 may be configured in a plurality of sizes and shapes including square shaped, rectangular shaped, cylinder shaped, cuboid shaped, hexagonal prism shaped, triangular prism shaped, or any other geometric or non-geometric shape, including combinations of shapes.

The float 10 may comprise a buoyancy element 12 that may be positioned within the body 11 of the float 10. In some embodiments, and as shown in FIGS. 2, 5, 7, the body 11 of the float 10 may encircle or contain the buoyancy element 12. In further embodiments, the body 11 of the float 10 may encircle or contain the buoyancy element 12 so that the buoyancy element 12 may generally move freely within the body 11 of the float 10. For example, the buoyancy element 12 may comprise a gas or air pocket contained within the body 11 which is generally able to move freely within the body 11 of the float 10. In alternative embodiments, the buoyancy element 12 may be positioned within the body 11 of the float 10 by being disposed in the body 11 itself. For example, the body 11 may comprise a plurality of air pockets, such as found in a foam material, which may be bound or otherwise coupled to the body 11.

In some embodiments, a buoyancy element 12 may comprise a material with a density that is less than the density of the liquid 300 (FIGS. 5, 7) that the float 10 is to be in contact with. In further embodiments, a buoyancy element 12 may comprise a gas such as nitrogen, helium, oxygen, argon, carbon dioxide, nitrous oxide, or any other gas. In still further embodiments, a buoyancy element 12 may comprise a mixture of gasses such as found in the atmosphere. In some alternative embodiments, a buoyancy element 12 may contain or comprise a volume which is in a vacuum. In further alternative embodiments, a buoyancy element 12 may be made from or comprise Styrofoam, expandable foam, other types of foam, wood, such as balsa wood, or any other generally solid material which may be less dense than water or any other liquid that the float 10 is to be in contact with. In still further embodiments, a buoyancy element 12 may be made from or comprise a liquid such as vegetable oil, olive oil, other types of preferably food safe oil, or any other suitable liquid.

In some embodiments, and as shown in FIGS. 2, 5, 7, the float 10 may comprise one or more optional counter weights 14 that may be positioned within the body 11 of the float 10. In further embodiments, the body 11 of the float 10 may encircle or contain a counter weight 14. In further embodiments, the body 11 of the float 10 may encircle or contain a counter weight 14 so that the counter weight 14 may generally move freely within the body 11 of the float 10. For example, a counter weight 14 may comprise a volume of liquid contained within the body 11 which is generally able to move freely within the body 11 of the float 10. In alternative embodiments, a counter weight 14 may be positioned within the body 11 of the float 10 by being disposed in the body 11 itself. For example, the body 11 may comprise one or more counter weights 14 disposed within a layer within or otherwise coupled to the material forming the body 11.

In some embodiments, a counter weight 14 may comprise a material with a density that is greater than or equal to the density of the liquid 300 (FIGS. 5, 7) that the float 10 is to be in contact with. In further embodiments, a counter weight 14 may comprise a liquid such as water, ethyl alcohol, or any other type of preferably food safe liquid having a density that is greater than or equal to the density of the liquid 300 that the float 10 is to be in contact with. In still further embodiments, a counter weight 14 may comprise a solid material such as plastic, metal, ceramic, which may optionally be fashioned into generally spherical shapes to facilitate or enable the movement of a counter weight within the float 10. In some alternative embodiments, a counter weight 14 may comprise a volume of the liquid 300 that the float 10 is to be in contact with.

Also shown in FIGS. 2, 5, 7, the float 10 may comprise a first magnetic material 31 disposed within the body 11 of the float 10. A first magnetic material 31 may optionally be made of or comprise a high-coercivity ferromagnetic compound such as ferric oxide mixed with a plastic binder. In other embodiments, a first magnetic material 31 may be made from or comprise ferrite, manganese-zince ferrite, nickel-zinc ferrite, strontium ferrite, cobalt ferrite, barium ferrite, magnetic alloys such as alnico, comol, hypernom, iron-silicon magnet alloys, magnet steel, chromindur, silmanal, platinax, bismanol, cobalt-platinum alloys, chromium-manganese antimonide, ultra-mag, vectolite, magnadur, lodex, awaruite, wairauite, rare earth magnets such as samarium-cobalt, cesium-cobalt, neodymium-iron-boron, metallic oxides such as magnetite, ulvospinel, hematite, ilmenite, maghemite, jacobsite, metallic sulfides such as pyrrhotite, greigite, troilite, metallic oxyhydroxides such as goethite, lepidocrocite, feroxyhyte, metals such as iron, nickel, cobalt, or any other suitable magnetic material that is capable of magnetically adhering to another magnetic material.

In some embodiments, and as shown in FIGS. 2, 5, 7, a first magnetic material 31 may be contained within one or more magnetic elements 14 which may be positioned within the body 11 of the float 10. Optionally, a magnetic element 14 may be movably positioned within the body 11 of the float 10 so that the magnetic element 14 may move generally freely within the body 11 of the float 10. For example, a magnetic element 14 may be configured with a generally spherical shape and may not be coupled to the body 11 so that the magnetic element 14 may generally roll around freely within the body 11. In alternative embodiments, a magnetic element 14 may be disposed within the body 11 of the float 10 by being disposed in the body 11 itself. For example, the body 11 may comprise one or more first magnetic materials 31 and/or magnetic elements 14 which may be formed into a layer within or otherwise coupled to the material forming the body 11.

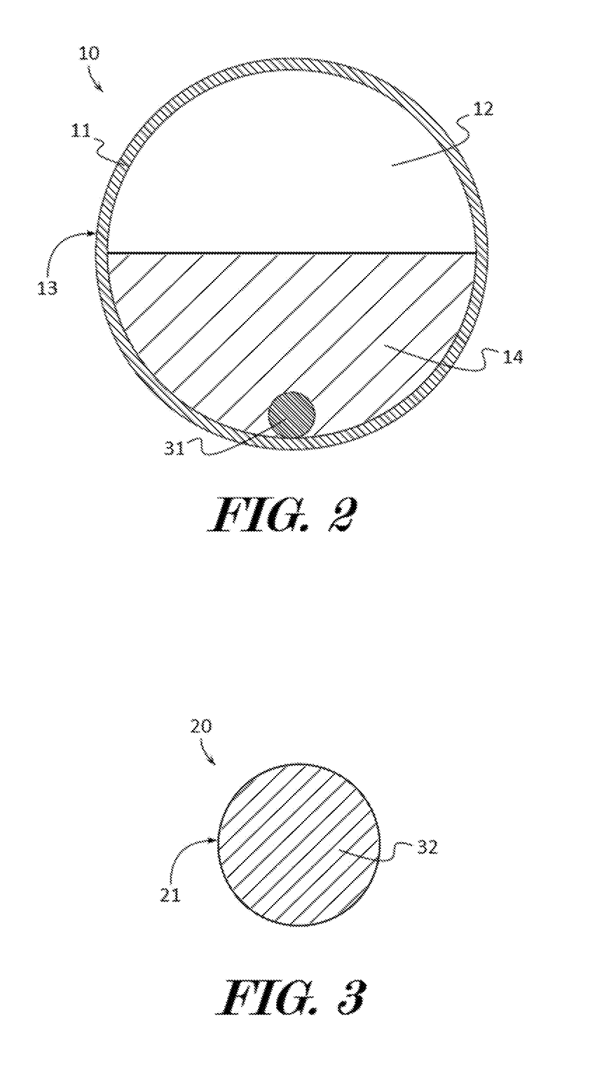

As perhaps best shown in the sectional elevation view of the level indicator 20 illustrated in FIG. 3, a level indicator 20 may comprise a second magnetic material 32. Similar to a first magnetic material 31 (FIGS. 2, 5, 7), a second magnetic material 32 may be made from or comprise any suitable magnetic material that is capable of magnetically adhering to another magnetic material. In some embodiments, a first magnetic material 31 may be made from or comprise the same magnetic material as the second magnetic material 32. In other embodiments, a first magnetic material 31 may be made from or comprise a different magnetic material than the second magnetic material 32. Generally, the magnetic materials used to form a first magnetic material 31 a second magnetic material 32 may be selected so that magnetic communication may be established and maintained between the float 10 (FIGS. 1, 2, 5, 7) and the level indicator 20 when the the float 10 and the level indicator 20 are in proximity to each other such as when on opposing sides or surfaces of a tank 200 (FIGS. 4-7). For example, a first magnetic material 31 may be made from or comprise a neodymium or other rare earth magnetic material and a second magnetic material 32 may comprise a ferrous metal so that magnetic communication may be established and maintained between the first magnetic material 31 of the float 10 and the second magnetic material 32 of the level indicator 20 when the the float 10 and the level indicator 20 are in proximity to each other and on opposing sides or surfaces of a tank 200 as shown in FIGS. 5, 7.

In some embodiments, the level indicator 20 may comprise an indicator exterior surface 21 which may be configured with a generally spherical shape and which may allow the level indicator 20 to roll along the exterior surface 201 (FIGS. 4-7) of the tank 200 (FIGS. 4-7). In alternative embodiments, the level indicator 20 may optionally comprise one or more movement facilitating devices such as wheels, casters, ball bearings, and the like, which may facilitate the movement of the level indicator 20 across the exterior surface 201, and the level indicator 20 may be configured in a plurality of sizes and shapes including square shaped, rectangular shaped, cylinder shaped, cuboid shaped, hexagonal prism shaped, triangular prism shaped, or any other geometric or non-geometric shape, including combinations of shapes. For example, the level indicator 20 may be configured with a decorative shape or football mascot and comprise one or more movement facilitating devices such as wheels, casters, ball bearings, and the like which may facilitate the movement of the level indicator 20 across the exterior surface 201. For both the level indicator 20 and the float 10, it is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Turning now to FIGS. 4-7, an example of a liquid tank level indicator device 100 engaged to an exemplary liquid tank 200 according to various embodiments described herein is depicted. The tank 200 depicted is exemplary in nature and the device 100 may be used with any type of liquid holding tank which comprises an exterior surface 201 and an interior surface 202 surrounding a cavity 210 shaped to contain a volume of liquid 300. The liquid 300 may comprise a free surface 301 is the surface of a liquid or fluid that is subject to both zero perpendicular normal stress and parallel shear stress, such as the boundary between the liquid and the air in the Earth's atmosphere. Since tanks 200 are generally calibrated to contain a certain volume of liquid in their respective cavities 210, the height of the free surface 301 of a liquid 300 within the cavity 210 may be used to estimate the volume of the liquid 300.

As shown in FIGS. 5 and 7, the float 10 may be positioned inside the cavity 210 of a tank 200 and in contact with the liquid 300 within the tank cavity 210 and in contact with the interior surface 202 of the tank 200. In preferred embodiments, the buoyancy of the float 10 may be configured so that the float 10 is bisected by the horizontal plane formed by the free surface 301 of the liquid 300. By increasing the amount of or adding a buoyancy element 12 and/or decreasing the amount of or removing a counter weight 14, the buoyancy of the float may be increased to raise the float 10 relative to the free surface 301. Conversely, by increasing the amount of or adding a counter weight 14 and/or decreasing the amount of or removing a buoyancy element 12, the buoyancy of the float may be decreased to lower the float 10 relative to the free surface 301.

The level indicator 20 may be placed on the exterior surface 201 of the tank 200 and proximate to the float 10 so that magnetic communication may be established and maintained between the first magnetic material 31 of the float 10 and the second magnetic material 32 of the level indicator 20. In this manner the magnetic communication between the float 10 and the level indicator 20 may maintain the level indicator in the same horizontal plane as the free surface 301 of the liquid 300, such as at a first height (H1) shown in FIG. 5. As liquid 300 is removed from the tank 200 the free surface 301 of the liquid 300 may move from H1 to a second height (H2) as shown in FIG. 7. As the free surface 301 moves to H2, the float 10 may also be moved to H2 and the magnetic communication between the float 10 and the level indicator 20 may draw the level indicator 20 to H2 to be in generally the same horizontal plane as the free surface 301 and the float 10. The reverse is also true in that, as liquid 300 is added to the tank 200, the free surface 301 of the liquid 300 may move from the second height (H2) as shown in FIG. 7 to the first height (H1) as shown in FIG. 5. As the free surface 301 moves to H1, the float 10 may also be moved to H1 and the magnetic communication between the float 10 and the level indicator 20 may draw the level indicator 20 to H1 to be in generally the same horizontal plane as the free surface 301 and the float 10. In preferred embodiments, both the float 10 and the level indicator 20 may comprise a spherical shape so that the float exterior surface 13 may roll across the interior surface 202 and the indicator exterior surface 21 may roll across the exterior surface 201.

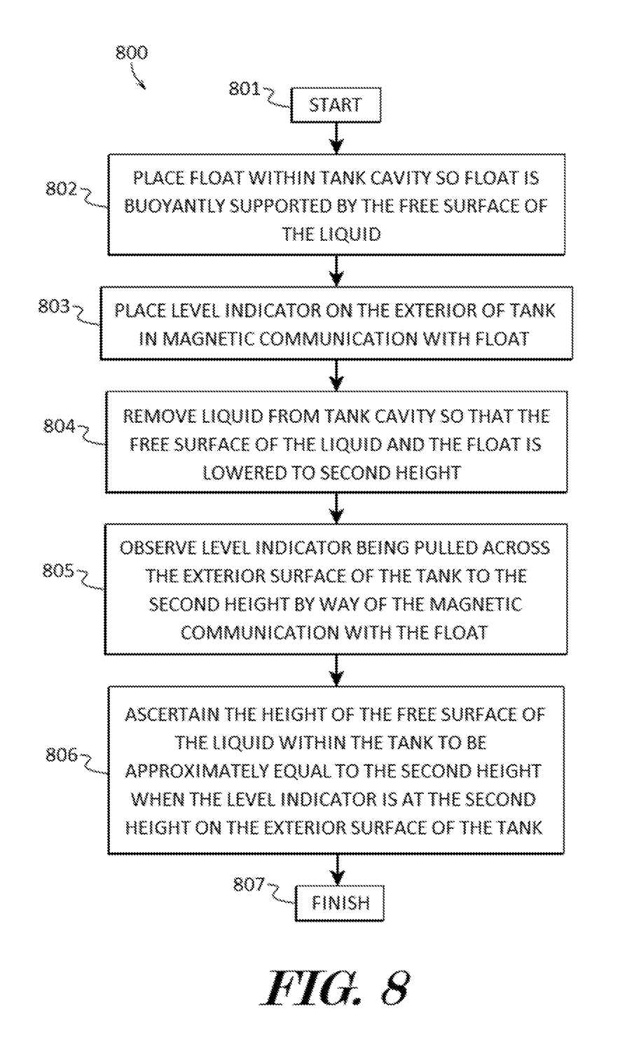

FIG. 8 illustrates a block diagram of an example of a method for determining the level of the free surface 301 (FIGS. 5, 7) of a liquid 300 (FIGS. 5, 7) in a tank 200 (FIGS. 4-7) (“the method”) according to various embodiments described herein. In some embodiments, the method 800 may be used for determining the level of the free surface 301 a tank 200 having an exterior surface 201 (FIGS. 4-7) and an interior surface 202 (FIGS. 5, 7) surrounding a cavity 210 (FIGS. 5, 7) shaped to contain a volume of the liquid 300 with a liquid tank level indicator device 100 (FIGS. 1, 5, 7). Preferably, the device 100 may include a float 10 (FIGS. 1, 2, 5, 7) having a body 11 (FIGS. 1, 2, 5, 7) with a buoyancy element 12 (FIGS. 2, 5, 7) and a first magnetic material 31 (FIGS. 2, 5, 7). Additionally, the device 100 may also comprise a level indicator 20 (FIGS. 1, 3-7) having a second magnetic material 32 (FIGS. 3, 5, 7).

In some embodiments, the method 800 may start 801 and the float 10 may be placed within the tank cavity 210 and into contact with the free surface 301 of the liquid 300 with the float 10 buoyantly supported by the free surface 301 of the liquid 300 at a first height (H1) FIG. 5 in step 802. In further embodiments, the float 10 may be positioned within the tank cavity 210 so that the float exterior surface 13 is in contact with or proximate to the interior surface 202 of the tank 200.

In step 803, the level indicator 20 may be placed or positioned on the exterior surface 201 of the tank 200 in magnetic communication with the float 10. Once positioned, the level indicator 20 may be maintained at the first height (H1) parallel to, or generally in the same horizontal plane as, the free surface 301 of the liquid 300 by the magnetic communication between the float 10, such as which may be provided by the first magnetic material 31 of the float 10 and the second magnetic material 32 of the level indicator 20. In further embodiments, the level indicator 20 may be positioned on the tank 200 so that the indicator exterior surface 21 is in contact with or proximate to the exterior surface 201 of the tank 200.

Next, liquid 300 may be removed from the tank cavity 210 so that the free surface 301 of the liquid 300 may be lowered from the first height (H1) to a second height (H2) (FIG. 7), resulting in the float 10 being lowered from the first height (H1) to the second height (H2) thereby also resulting in the level indicator 20 being moved or pulled across the exterior surface 201 of the tank 200 to the second height (H2) by way of the magnetic communication between the float 10 and the level indicator 20 in step 804.

In step 805, the level indicator 20 may be observed being moved or pulled across the exterior surface 201 of the tank 200 to the second height (H2) by way of the magnetic communication between the float 10 and the level indicator 20.

Next, in step 806 the height of the free surface 301 of the liquid 300 within the tank 200 may be ascertained to be approximately equal to the second height (H2) as the level indicator 20 is at the second height (H2) on the exterior surface 201 of the tank 200. In further embodiments, the difference between H2 and H1 may be used to ascertain the approximate change in the volume of the liquid 300 within the tank 200. After step 806, the method 800 may finish 807.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A liquid tank level indicator device for use with a tank having an exterior surface and also having an interior surface surrounding a cavity shaped to contain a volume of liquid, the device comprising:
a float having a body, said float positioned within the tank cavity;
a buoyancy element positioned within the body of the float;
a first magnetic material disposed within the body of the float;
a level indicator comprising a second magnetic material, the level indicator positioned on the exterior surface of the tank, and
wherein the second magnetic material of the level indicator is placed in magnetic communication with the first magnetic material of the float so that movement of the float results in movement of the level indicator.

2. The device of claim 1, wherein the buoyancy element comprises a gas.

3. The device of claim 1, wherein the body of the float is spherical in shape.

4. The device of claim 1, wherein level indicator is spherical in shape.

5. The device of claim 1, wherein the float comprises a counter weight positioned within the body.

6. The device of claim 5, wherein the counter weight is a liquid.

7. The device of claim 1, wherein the magnetic material is disposed within a magnetic element, and wherein the magnetic element is positioned within the body of the float.

8. The device of claim 7, wherein the magnetic element is movably positioned within the body of the float.

9. The device of claim 7, wherein the magnetic element is spherical in shape.

10. The device of claim 1, wherein the body comprises a food grade material.

11. A method for determining the level of the free surface of a liquid in a tank, the tank having an exterior surface and also having an interior surface surrounding a cavity shaped to contain a volume of liquid with a liquid tank level indicator device, the device comprising:
a float having a body, said float configured to contact the interior surface of the tank cavity;
a buoyancy element positioned within the body of the float;
a first magnetic material disposed within the body of the float;
a level indicator comprising a second magnetic material, the level indicator configured to contact the exterior surface of the tank; and
the method comprising the steps of:
placing the float within the tank cavity and into contact with the free surface of the liquid, wherein the float is buoyantly supported by the free surface of the liquid at a first height (H1);
placing the level indicator on the exterior surface of the tank in magnetic communication with the float, said level indicator maintained at the first height (H1) parallel to the free surface of the liquid by the magnetic communication with the float;
removing liquid from the tank cavity so that the free surface of the liquid is lowered from the first height (H1) to a second height (H2), wherein the float is lowered from the first height (H1) to the second height (H2);
observing the level indicator being pulled across the exterior surface of the tank to the second height (H2) by way of the magnetic communication with the float; and
ascertaining the height of the free surface of the liquid within the tank to be approximately equal to the second height (H2) when the level indicator is at the second height (H2) on the exterior surface of the tank.

12. The device of claim 10, wherein the buoyancy element comprises a gas.

13. The device of claim 10, wherein the body of the float is spherical in shape.

14. The device of claim 10, wherein level indicator is spherical in shape.

15. The device of claim 10, wherein the float comprises a counter weight positioned within the body.

16. The device of claim 14, wherein the counter weight is a liquid.

17. The device of claim 1, wherein the magnetic material is disposed within a magnetic element, and wherein the magnetic element is positioned within the body of the float.

18. The device of claim 17, wherein the magnetic element is movably positioned within the body of the float.

19. The device of claim 17, wherein the magnetic element is spherical in shape.

20. The device of claim 10, wherein the body comprises a food grade material.
